(19) United States
(12) Patent Application Publication
(10) Pub. No.: US 2026/0208142 A1
(43) Pub. Date: Jul. 23, 2026

(54) HEAT TREATMENT MEANS FOR PRINTING DEVICE OF AN ENZYMATIC SYNTHESIS APPARATUS

(71) Applicant: DNA Script, Le Kremlin-Bicêtre (FR)

(72) Inventors: Adrian HORGAN, Le Kremlin-Bicêtre (FR); Damiano VERARDO, Le Kremlin-Bicêtre (FR)

(21) Appl. No.: 19/144,006

(22) PCT Filed: Dec. 29, 2023
(86) PCT No.: PCT/EP2023/087966

§ 371 Date: Jun. 27, 2025

(30) Foreign Application Priority Data
Dec. 31, 2022 (FR) FR2214739

(51) Int. Cl. B01J 19/00

(52) U.S. Cl. CPC B01J 19/0046; B01J 2219/00385; B01J 2219/00495; B01J 2219/00709; B01J 2219/00722

(57) ABSTRACT

The present invention relates to a printing device (1) configured for the enzymatic synthesis of biomolecules, comprising a printing head (2), at least one ink reservoir (7) containing synthesis reagents and a substrate plate (16) configured to receive ink drops (6), the printing device (1) being equipped with heat treatment means (26) configured to generate a positive temperature differential between the print head (2) and/ or the ink reservoir (7) on the one hand and the substrate plate (16) on the other.

The present invention relates to the field of devices for the enzymatic synthesis of biomolecules, and more particularly to devices for the synthesis of polynucleotides such as RNA and/or DNA by inkjet printing.

DNA and/or RNA polynucleotides are linear polymers of nucleotide monomers or analogues thereof that can bind specifically to other polynucleotides through a regular pattern of interactions between monomers. Polynucleotides generally range in size from a few monomers—for example, from 5 to 40 monomers, in which case they may be called “oligonucleotides”—to several thousand monomers. Usually, polynucleotides comprise the four natural nucleotides, e.g. deoxyadenosine, deoxycytidine, deoxyguanosine, deoxythymidine for DNA or their ribose equivalents for RNA, linked by phosphodiester bonds; however, they can also comprise non-natural nucleotide analogues, e.g. modified bases, sugars or internucleoside linkages.

When an inkjet printing device is used in an apparatus for enzymatic synthesis of DNA and/or RNA, defined quantities of an enzymatic solution can be delivered to precise locations on a substrate comprising DNA and/or RNA initiator fragments. The enzyme solution, which contains synthesis reagents including enzymes, can for example be deposited on the substrate in the form of ink drops.

The viscosity of a fluid, in this case ink, is a measure of its resistance to deformation. This is an important parameter in inkjet printing, as excessive ink viscosity limits enzyme movement and can therefore hinder elongation taking place on the substrate. An acceptable viscosity for enzyme activity is generally considered to be similar to the viscosity of water, i.e. around 1 centipoise (cP).

Viscosity depends on fluid composition, concentration and temperature. The higher the temperature, the less viscous the fluid, and conversely, the lower the temperature, the more viscous the fluid.

It is generally accepted that an ink has suitable ejection properties when it forms a stable jet, does not lead to the formation of satellite ink droplets, and does not lead to significant clogging of the nozzle. For an ink with such characteristics, the viscosity should generally be between 3 and 20 cP.

The present invention fits into this context by proposing a printing device in which the ink at the nozzles and the ink deposited on the substrate each have optimal temperatures and viscosities, respectively for ejection from the nozzles and for the progress of enzyme synthesis and more particularly of the elongation step.

The main object of the present invention is thus a printing device configured for the enzymatic synthesis of biomolecules, comprising a print head, at least one ink reservoir containing synthesis reagents and a substrate plate configured to receive ink drops, the printing device being equipped with heat treatment means configured to generate a positive temperature differential between the print head and/or ink reservoir on the one hand and the substrate plate on the other.

The printing device according to the invention enables the enzymatic synthesis of polynucleotides, e.g. fragments of interest or complete biomolecules. For this purpose, ink is conveyed from the reservoir to the print head under the effect of gravity. The ink is then deposited onto the substrate plate in the form of droplets by nozzles on the printhead.

This substrate plate is where enzymatic synthesis takes place. It carries initiator fragments destined to undergo an elongation step, which is carried out using synthesis reagents contained in the ink droplets. These synthesis reagents include enzymes, which require a suitable temperature to catalyze the elongation step. Such a temperature at substrate plate level can be achieved by thermal treatment means of the printing device.

The temperature of the ink reservoir and/or printhead is also regulated by the heat treatment means. This means that the ink at the nozzles, and therefore at the moment of ejection, has a viscosity that ensures optimum ejection capacity. The temperature and viscosity depend on this to prevent clogging of the nozzles or the deposition of satellite ink droplets on the substrate plate.

By regulating the temperature both at the printhead and/or reservoir on the one hand and at the substrate plate on the other, a positive temperature differential is generated within the printing device, with the temperature at the substrate plate being higher than at the printhead and/or ink reservoir.

In the know prior arts, the goal was to increase the temperature to decrease the viscosity of the ink. Here we need to ensure that the viscosity is high enough at the nozzles for ejection from the nozzles and low enough on the plat to permit the enzymatic reaction. So, the problem is different from the one from the prior art where the goal was only to decrease or increase the viscosity.

The use of heat treatment means makes it possible to regulate ink viscosity without the need to add viscosity modifiers, which could denature the synthesis reagents. There may, however, be embodiments in which such viscosity modifiers are added to the heat treatment means.

According to a feature of the invention, the heat treatment means are configured to generate a temperature differential of at least 10° C. between the print head and/or ink reservoir on the one hand and the substrate plate on the other.

According to one feature, the heat treatment means are configured so that a temperature measured at the printhead and/or ink tank is between 0 and 25° C. and a temperature measured at the substrate plate is between 25 and 60° C.

The range of temperature values measured at the printhead and/or ink reservoir corresponds to temperatures at which the ink exhibits correct ejection capabilities. The temperature range measured at the substrate plate relates to temperatures suitable for enzymatic reactions, in particular the elongation reaction. Temperatures at the substrate plate that are too high, e.g. over 60° C., could lead to ink evaporation, compromising elongation. An optimum temperature for most enzymes is around 37° C., which corresponds to human body temperature; other, more specific enzymes, however, can function optimally at temperatures between 37° C. and 60° C.

Another feature of the invention is that the heat treatment means include cooling means for the print head and/or ink tank.

According to a feature of the invention, the heat treatment means comprise heating means downstream of the print head.

It is understood here that the heat treatment means can take the form of cooling means and/or heating means. The purpose of the cooling means is to cool the print head, the ink reservoir or both; it is thus understood that these cooling means are dedicated to cooling the ink upstream of its ejection through the print head nozzles. Conversely, the heating means provide thermal treatment downstream of the printhead. Such thermal treatment may, for example, take the form of heating the substrate plate.

According to one feature, the cooling means are arranged on at least one printhead feed duct.

The supply line(s) are ink supply lines that form part of the printing device. Such conduits may, for example, connect the reservoir to the print head. The cooling means are optionally arranged around the supply conduit, and optionally along the entire length of this supply conduit.

According to one feature, the cooling means are arranged on the ink tank.

It is understood here that the cooling means are arranged against part of the tank, optionally all around it. In addition to the cooling means, the ink tank can also be equipped with stirring means to stir the ink in order to facilitate convection phenomena.

According to a feature of the invention, the cooling means comprise a housing within which the print head and/or ink tank are arranged.

Thus, either the printhead or the ink reservoir, or both, can be housed in an enclosure, such as a hermetic or sealed enclosure, within which the temperature is regulated by cooling means.

According to one feature, the heating means comprise a thermal block arranged in contact with the substrate plate.

The substrate plate comprises a face in which wells or reaction sites are formed, onto which the ink containing the synthesis reagents is deposited, and an opposite face against which, or in the vicinity of which, the thermal block is arranged. This thermal block is, for example, an electric radiator with resistive elements.

According to one feature, the heating means comprise a system for infrared irradiation of the substrate plate.

According to one feature, the heating means comprise a circulation zone configured for the passage of a flow of heat transfer fluid, the substrate plate being arranged in overlap with this circulation zone.

Such a circulation zone is arranged opposite the face carrying the reaction sites. The temperature of the substrate plate is regulated by circulating the heat transfer fluid within the circulation zone. By “heat transfer fluid” or “hot fluid” we mean a fluid whose temperature enables it to transfer heat to the substrate plate.

According to one feature, the printing device comprises a cover configured to cover the substrate plate, this cover comprising heating means.

Such a cover, which is therefore heated, is placed on top of the substrate plate during an incubation stage of enzyme synthesis, and then removed at the end of this stage.

According to a further feature of the invention, the printing device comprises means for isolating the substrate plate.

The insulating means is an insulating film such as a polyimide film, which during insulation remains stable over a wide temperature range, for example from −269 to 400° C. It is arranged so as to envelop the substrate plate and/or the support platform, to ensure that calories transferred to the substrate plate by the heating means do not evaporate during the enzymatic reaction.

According to one feature, the printing device comprises means for moistening the substrate plate.

Such humidification means ensure that the incubation stage takes place at a humidity level that prevents ink evaporation.

According to one feature, the printing device comprises an enclosure configured to cover the substrate plate, this enclosure comprises heating means, a temperature-humidity controller.

Such an enclosure ensures stabilizing environmental conditions and act against perturbation to maintain the desired temperature and humidity.

According to one feature, the enclosure comprises at least one fan.

Other features, details and advantages of the invention will become clearer on reading the following description on the one hand, and examples of embodiments given by way of indication and non-limitation with reference to the appended drawings on the other hand, on which:

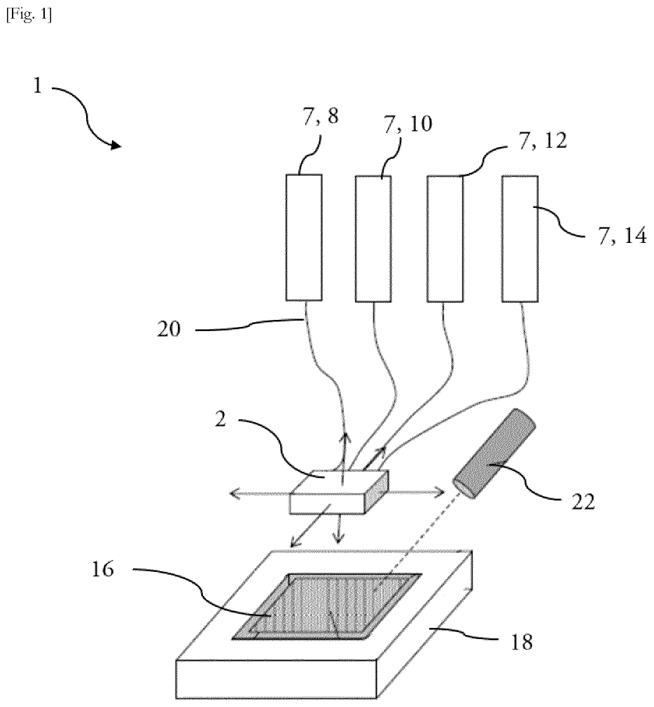

FIG. 1 illustrates, schematically, an enzymatic synthesis apparatus comprising a printing device according to the invention, according to a perspective view;

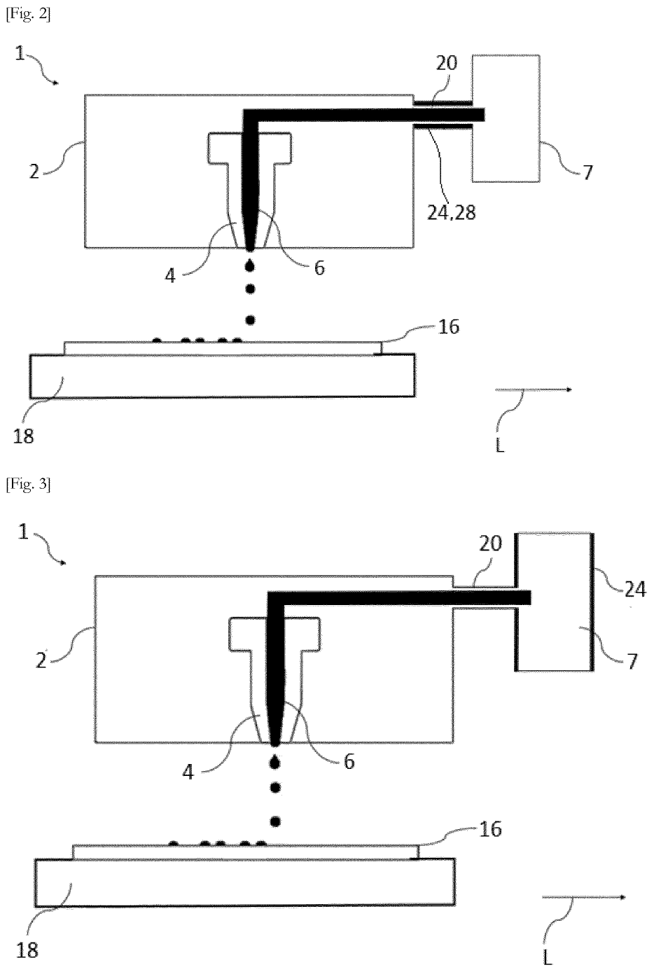

FIG. 2 illustrates, schematically, the printing device of FIG. 1 being equipped with heat treatment means according to a first embodiment;

FIG. 3 illustrates, schematically, the printing device of FIG. 1 being equipped with heat treatment means according to a second embodiment;

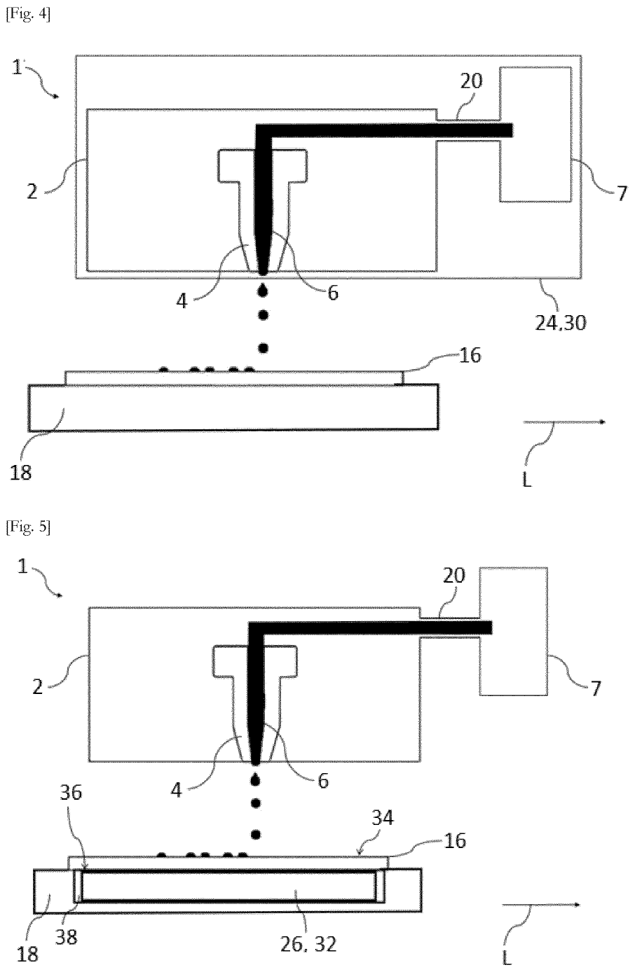

FIG. 4 illustrates, schematically, the printing device of FIG. 1 being equipped with heat treatment means according to a third embodiment;

FIG. 5 illustrates, schematically, the printing device of FIG. 1 being equipped with heat treatment means according to a fourth embodiment;

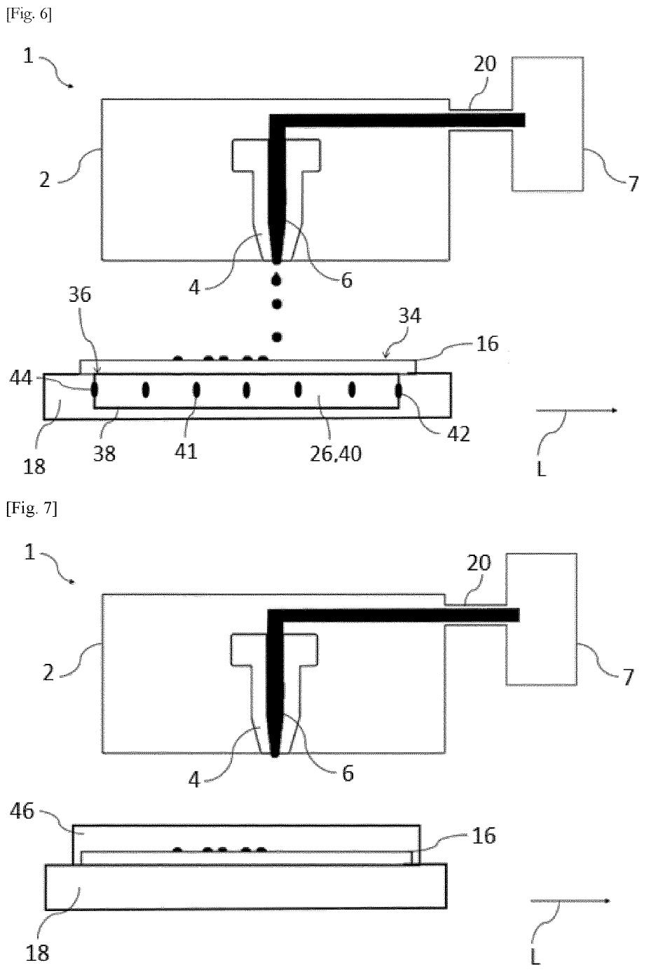

FIG. 6 illustrates, schematically, the printing device of FIG. 1 being equipped with heat treatment means according to a fifth embodiment;

FIG. 7 illustrates, the printing device of FIG. 1 being equipped with heat treatment means according to a sixth embodiment;

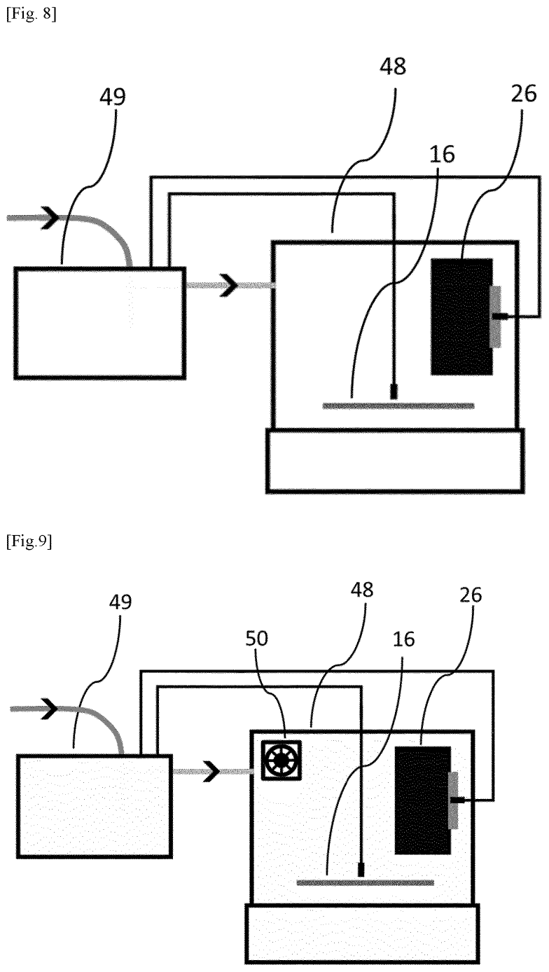

FIG. 8 illustrates, the printing device of FIG. 1 being equipped with heat treatment means according to a seventh embodiment;

FIG. 9 illustrates, the printing device of FIG. 1 being equipped with heat treatment means according to a eighth embodiment;

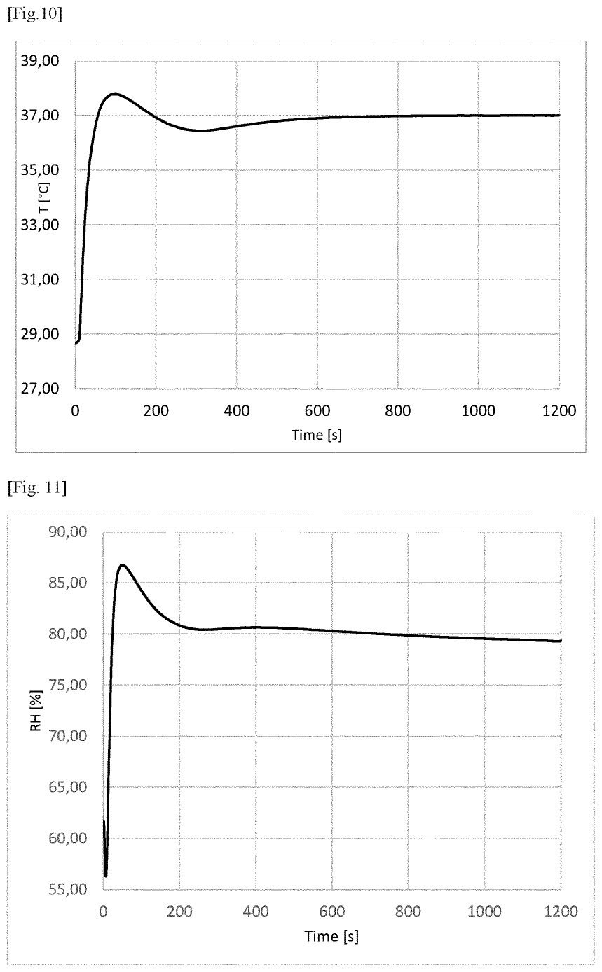

FIG. 10 illustrates the temperature variation during the elongation step according to a seventh embodiment;

FIG. 11 illustrates the relative humidity variation during the elongation step according to a seventh embodiment.

The features, variants and different embodiments of the invention may be combined with one another in various ways, provided they are not mutually exclusive or incompatible. In particular, it is possible to imagine variants of the invention comprising only a selection of features described hereinafter in isolation from the other features described, if this selection of features is sufficient to confer a technical advantage and/or to differentiate the invention from the prior art.

In the figures, elements common to several figures retain the same reference.

FIGS. 1 to 8 schematically illustrate an enzymatic synthesis apparatus comprising at least one inkjet printing device 1, such a printing device 1 being configured for the enzymatic synthesis of polynucleotides. These polynucleotides can be biomolecules such as DNA and/or RNA molecules, whether in single-stranded or double-stranded form.

The printing device 1 comprises a print head 2 equipped with nozzles 4, one of these nozzles 4 being particularly visible in FIGS. 2 to 6, which correspond to different embodiments. The printing device 1 is configured so that ink 6 can be pumped from one or more ink tanks 7 to the nozzles 4. The ink 6 used in the printing device 1 contains enzymatic synthesis reagents that are required for an elongation reaction. These enzymatic synthesis reagents may comprise a nucleoside triphosphate, the 3′—OH end of which is protected, and an elongation enzyme. The nucleoside triphosphate can be protected on its gamma phosphate. Alternatively, the synthesis reagents may comprise tetraphosphate or pentaphosphate nucleotides in addition to the elongation enzyme. The elongation enzyme may, for example, be a polymerase: if the molecule to be synthesized is a DNA molecule, the polymerase will be a DNA polymerase, whereas if an RNA molecule is required, the polymerase will be an RNA polymerase. The nucleoside triphosphate contained in enzymatic synthesis reagents is protected, i.e. it is associated with an aminoxy protecting group to block its elongation.

As already mentioned, the ink 6 used in the printing device 1 can be stored in an ink reservoir 7. Such an ink reservoir 7 may, for example, take the form of ink cartridges. The number of ink cartridges depends on the number of 3′—OH-protected nucleoside triphosphates required for the elongation reaction and available in the printing device 1. These nucleoside triphosphates are modified adenine, modified cytosine, modified guanine, modified thymine and/or modified uracil. Consequently, there may be as ink reservoirs 7 and as illustrated in FIG. 1, a first ink cartridge 8 for ink 6 containing modified adenine and elongation enzyme, a second ink cartridge 10 for ink 6 containing modified cytosine and elongation enzyme, a third ink cartridge 12 for ink 6 containing modified guanine and the elongation enzyme, and a fourth ink cartridge 14 for ink 6 containing modified thymine and/or modified uracil and the elongation enzyme.

The enzymatic synthesis reagents present in ink 6 are intended to be deposited on a substrate plate 16. This substrate plate 16 can be glass, silica, silicon oxide, plastic or similar surfaces, but also other surfaces such as biological tissue. Such surfaces may be patterned and may also include functional components such as electrodes. Here, the substrate plate 16 is arranged on a support platform 18, which in particular enables the substrate plate 16 to be moved between various stations or operating stations of the enzyme synthesizer, or even within the same operating station. It is thus understood that the substrate plate 16 is mobile within the enzyme synthesizer. Such mobility can, for example, be implemented by computer control, in particular via software installed on a computer. In other particular embodiments, the print head 2 can also or alternatively be mobile within the printing device 1.

The substrate plate 16 comprises several reaction sites. Each reaction site is distinct from the other reaction sites and they do not overlap; in other words, the reaction sites are not contiguous. Each reaction site contains at least one initiator with a free 3′—OH end, also known as an initiator fragment. This initiator fragment is a short nucleotide fragment whose elongation results in a polynucleotide, which may be a DNA polynucleotide if the initiator fragment is a DNA fragment, or an RNA polynucleotide if the initiator fragment is an RNA fragment. The reaction sites are arranged in rows, for example, these rows extending perpendicularly to a longitudinal direction L corresponding to a main extension direction of the substrate plate 16. The rows are arranged successively on the substrate plate 16 along this longitudinal direction L.

The enzymatic synthesis apparatus and its printing device 1 are used as part of a method for enzymatic synthesis of such polynucleotides. This enzymatic synthesis method comprises various steps, the completion of which forms a cycle. At the end of a cycle, at least some of the initiator fragments will have been lengthened by one nucleotide each. The repetition of several cycles leads to the synthesis of polynucleotides, and the appropriate selection of the type of ink, i.e. the type of nucleoside triphosphate projected at a given moment onto a given reaction site, at each cycle makes it possible to obtain polynucleotides of a predetermined sequence.

As already mentioned, the support platform 18 is mobile. It can thus be moved, within the enzyme synthesis device, to a printing station comprising the printing device 1 and within which ink 6 can be deposited on the substrate plate 16 from the ink reservoir 7. For this purpose, the substrate plate 16 is positioned under the print head 2 of the printing station, and more precisely under the spray nozzles 4 of this print head 2.

Once the substrate plate 16 is supported by the suitably positioned support platform 18 beneath the printhead 2, ink 6 flows from the ink reservoir 7 through a feed duct 20 to the nozzles 4, from which it is ejected, as shown in FIGS. 2 to 6. These nozzles 4 thus deliver ink drops onto the reaction sites of the substrate plate 16, enabling deposition of the enzymatic synthesis reagents in these reaction sites. Such deposition is facilitated, when required by the dimensions of the substrate plate 16, by the movement of the print head 2 relative to this substrate plate 16, so that the nozzles 4 of this print head 2 can be positioned successively opposite each row of reaction sites. In other alternative embodiments, one or more printheads could be attached to the printhead 2 of the printing device 1, so as to cover an area corresponding to the dimensions of the substrate plate 16. It would also be possible to envisage embodiments in which only the substrate plate 16 is moved under the print head 2, or both the substrate plate 16 and the print head 2 are moved relative to each other to facilitate deposition of ink 6 in the reaction sites.

The role of the elongation enzyme contained in Ink 6 is to elongate the initiator fragments present in the reaction sites, using nucleoside triphosphates modified so that their 3′—O ends are protected and which are also contained in Ink 6. More precisely, the elongation enzyme adds a single modified nucleotide to a free 3′—OH end of a terminating nucleotide of a given initiator fragment, generating an elongated initiator fragment. Due to the modified nature of the nucleotides that are blocked at their 3′—OH end, for example with an aminoxy protecting group, in a given drop of ink, once a first such modified nucleotide has grafted to the initiator fragment, no further nucleotides can graft, since the free end of the strand thus formed is protected. In other words, for a given drop of ink, only one of the nucleotides present in the drop is capable of binding to the free-terminating nucleotide of the initiating fragment. This protection ensures that nucleotides are added to the initiator fragment one by one for each cycle, thus avoiding errors in the polynucleotide sequence.

The elongation reaction can take place during an incubation step, which corresponds to a time required for elongation. The enzymatic synthesis method then includes a deprotection step, during which the elongated fragments protected at their 3′—OH ends are deprotected to form elongated fragments with a free 3′—OH end. The deprotection step is therefore a removal of the aminoxys protecting groups from the elongated fragments, so that the elongated fragments can be elongated again in a subsequent cycle. The deprotection step is carried out by a deprotection solution containing specific reagents such as reducing agents or enzyme cleavage enzymes. The substrate plate 16 carried by the support platform 18 can, for example, be immersed in a bath of this deprotection solution for the implementation of this deprotection step. The deprotection step can be followed by a cleaning step in a cleaning station of the enzyme apparatus, during which the substrate plate 16 is immersed in a bath of washing or rinsing solution. In addition to the above-mentioned operating stations, the enzyme synthesizer can also include an imaging station. Such an imaging station, which enables the progress of the enzyme synthesis to be verified, comprises a microscope incorporating a digital camera 22, which is used to detect the presence and/or positioning of ink drops on the substrate plate 16. The camera 22 generates images of the substrate plate 16. Such images are then processed by software integrated into the printing device 1, this software being capable of analyzing information such as the presence, absence, size, shape, relative positioning or content of ink drops deposited on the substrate plate 16, for example to ensure that the ink drops have not overlapped or overflowed the reaction sites.

According to the invention, the printing device 1 is equipped with heat treatment means 24, 26 which enable the temperature within it to be regulated. Such heat treatment means 24, 26 are illustrated in FIGS. 2 to 8, which correspond to different embodiments.

Thermal treatment means 24, 26 are used to regulate the temperature of the ink 6 prior to its ejection through the nozzles 4 and/or to regulate the temperature of the substrate plate 16 intended to receive drops of ink 6, with the aim of adapting the viscosity of the ink according to its location. For this purpose, the printing device 1 is equipped with cooling means 24, which are located in the print head 2 and/or ink tank 7. The printing device 1 also has heating means 26 downstream of the print head 2, for example at the substrate plate 16.

The presence of such heat treatment means 24, 26 creates a positive temperature differential within the printing device 1, whereby a temperature measured at the print head 2 and/or ink tank 7 is lower than a temperature measured at the substrate plate 16. This positive temperature differential ensures, on the one hand, that the ink 6 ejected by the nozzles 4 has an optimum viscosity, i.e. between 3 and 20 cP, so that the ink does not block these nozzles 4, and, on the other hand, that the elongation reaction mentioned above takes place on the substrate plate 16 under conditions suitable for the operation of the enzymes present in the synthesis reagents deposited on this substrate plate 16, with a viscosity of around 1 cP, for example.

An optimum temperature for the ink 6 to have optimum viscosity at the nozzles 4 is, for example, between 0 and 25° C. The heat treatment means 24, 26, and more particularly the cooling means 24, are therefore configured so that the temperature measured at the printhead 2 is between 0 and 25° C. In embodiments where the heat treatment means 24, 26 are configured to regulate a temperature at the ink tank 7, i.e. upstream of the print head 2 and nozzles 4, the temperature can also be between 0 and 25° C. or lower than these values. A temperature below 0° C. is possible, for example, if glycerol is added to ink 6, which then acts as an antifreeze and stabilizes the enzymes present in the synthesis reagents.

As already mentioned, the printing device 1 comprises one or more ink tanks 7. In some embodiments, although not shown here, in the presence of a plurality of ink tanks 7, one of these ink tanks 6 is used to fill the other ink tank(s) 7. These ink tanks 7 may in this case have different temperatures. The heat treatment means 24, 26 are then configured so that the ink reservoir 7 closest to the print head 2 has a higher temperature than the ink reservoir 7 which supplies it with ink 6. For example, the ink tank 7 closest to the printhead 2 may have a temperature of around 4° C.

Just as the viscosity of ink 6 depends on an optimum temperature range, an optimum temperature for enzyme operation is between 25 and 60° C. The heat treatment means 24, 26 and more precisely the heating means 26 are therefore configured so that the temperature measured at the substrate plate 16 is between 25 and 60° C.

The heat treatment means 24, 26 are further configured to generate a temperature differential of at least 10° C. between the printhead 2 and/or ink tank 7 on the one hand, and the substrate plate 16 on the other.

FIGS. 2 to 4 illustrate different versions of the cooling means 24, while FIGS. 5 to 8 show the heating means 26 in three different versions. Although such cooling means 24 and heating means 26 are shown here separately and alternately, it would be conceivable, without departing from the scope of the invention, to envisage modes of implementation in which they would be combined, be it a combination of different cooling means 24, different heating means 26, or even both cooling means 24 and heating means 26.

In FIG. 2, the cooling means 24 fitted to the printing device 1 as part of the heat treatment means 24, 26 are arranged on the supply line 20 which connects the ink tank 7 to the print head 2. The cooling means 24 comprise a sheath 28 arranged around the supply duct 20. Sheath 28 can be traversed by a cooling fluid. This sheath 28 extends along the entire length of this supply duct 20, from its end connected to the ink tank 7 to its end connected to the print head 2. Alternatively, and without departing from the scope of the invention, sheath 28 could extend at points around feed duct 20.

In the embodiment shown in FIG. 3, the cooling means 24 are arranged on the ink tank 7. More specifically, the cooling means 24 comprise a cooling plate pressed against an external face of a peripheral wall of the ink tank 7. A single peripheral wall may be covered by a cooling plate or, as illustrated, such plates may be arranged all around the ink tank 7. The cooling plate(s) can be supplied with a cooling fluid.

As shown in FIG. 4, the cooling means 24 can take the form of a housing 30 containing the print head 2 and ink tank 7. Alternatively, it could be a housing 30 enclosing only the print head 2 or only the ink tank 7. The housing 30 is an insulating box. It can thus be made of a thermally insulating material, so as to avoid heat exchange with the ambient temperature of a room in which the printing device 1 is located. An interior of the housing 30 is air-conditioned, for example, and a homogeneous temperature can be applied to this interior via thermal regulation means.

FIG. 5 illustrates an embodiment in which the heating means 26 comprise a thermal block 32. This thermal block 32, configured to release heat, is arranged in contact with the substrate plate 16. This substrate plate 16 more particularly comprises an upper face 34, which during the printing step is arranged facing the print head 2, and a lower face 36 opposite the upper face 34. It is understood here that the upper face 34 is the one carrying the reaction sites and that it is thus on this upper face 34 that the ink 6 is deposited in the form of drops. The thermal block 32 is positioned against the lower face 36, i.e. opposite the reaction sites. For this purpose, the support platform 18 on which the substrate plate 16 rests may have a recess 38 to accommodate the thermal block 32, so that the substrate plate 16 is positioned against and overlapping it.

Thermal block 32 is an electric radiator comprising one or more resistive elements. It is electrically powered, for example by a battery, so that the resistive elements generate heat and heat the substrate plate 16. The thermal block 32 can be controlled remotely. It may be removable, so that it can be removed from recess 38, for example, to recharge it or change its battery.

As shown in FIG. 6, the recess 38 in the support platform 18 can alternatively be used to delimit a heat transfer fluid circulation zone 40, which forms a heating means 26. The substrate plate 16 overlaps this circulation zone 40, so that its underside 36 participates in delimiting the circulation zone 40. Such a circulation zone 40 is configured for the passage of a flow of heat transfer fluid, for example air, another gas or a liquid. The heat transfer fluid circulation zone 40 therefore has circulation channels 41 in the support platform 18, winding through it, as well as a fluid inlet 42 at a first end of the recess 38 in the support platform 18 and a fluid outlet 44 at a second, opposite end of the recess 38. Such an arrangement of the fluid inlet and outlet 42, 44 enables optimum circulation of the heat transfer fluid within the circulation zone 40 and more precisely in the circulation channels 41 for the purpose of heating the substrate plate 16.

Although not shown in the figures, the heating means 26 of the printing device 1 could include a system for irradiating the substrate plate 16 with infrared radiation.

As shown in FIG. 7, the printing device 1 comprises a cover 46, which is equipped with heating means 26. The cover 46 is a removable part of the printing device 1 which can be placed on the support platform 18 to cover the substrate plate 16; in particular, it is used to cover the substrate plate 16 during the incubation stage when elongation takes place. The cover 46 is placed over the substrate plate 16 once the ink 6 has been deposited on the substrate plate 16, and is then removed prior to the deprotection step. As heating means 26, the cover 46 may comprise a thermal block, a heat-transfer fluid circulation zone, or an irradiation system.

Irrespective of the type(s) of heating means 26 chosen, such heating means 26 can be supplemented by an insulating means to retain the heat they generate. Such insulating means may take the form of an insulating film that envelops the support platform 18 carrying the substrate plate 16 and/or the cover 46 in order to seal them. Such an insulating film is, for example, a polyimide film.

The printing device 1 also includes means for humidifying the substrate plate 16, for example a humid air circulation channel in the support platform 18 and/or in the cover 46. This humidifying means is used in conjunction with the heating means 26, so that use of these heating means 26 does not result in evaporation of the ink 6 that has been deposited on the substrate plate 16. The humidification means thus enable a degree of humidity conducive to elongation to be maintained during the incubation stage.

As shown in FIG. 8, the printing device 1 comprises an enclosure 48, which is equipped with heating means 26, a temperature-humidity controller 49. The substrate plate 16 is moved in the enclosure 48 during the incubation stage when elongation takes place. As heating means 26, the enclosure 48 may comprise a thermal block, a heat-transfer fluid circulation zone, a heat sink or an irradiation system.

As shown in FIGS. 10 and 11, the temperature and the relative humidity stay constant over time after a quick stabilization period with this system.

As shown in FIG. 9, the printing device 1 comprises an enclosure 48, which is equipped with heating means 26, a temperature-humidity controller 49 and at least one fan 50. The substrate plate 16 is moved in the enclosure 48 during the incubation stage when elongation takes place. As heating means 26, the enclosure 48 may comprise a thermal block, a heat-transfer fluid circulation zone, a heat sink or an irradiation system.

It is clear from the description of the various embodiments that the present invention achieves its stated aims, by providing an inkjet printing device for enzymatic synthesis enabling both a temperature of the ink at the nozzles of the printing device and a temperature of the ink deposited on a substrate to be regulated, so that a viscosity of this ink is adapted respectively to ejection from the nozzles and to the progress of an elongation stage of the enzymatic synthesis.

However, the present invention is not limited to the means and configurations described and illustrated herein, and extends equally to any equivalent means and configurations, as well as to any technically operative combination of such means.

1. A printing device configured for the enzymatic synthesis of biomolecules, comprising
a print head,
at least one ink reservoir containing synthesis reagents, and
a substrate plate configured to receive ink drops,
wherein the printing device comprises at least one of a heater and a cooler configured to generate a temperature differential between the substrate plate and at least one of the print head and the ink reservoir,
wherein the temperature differential is at least 10° C., and wherein the temperature of the substrate plate is higher than the temperature of the at least one of the print head and the ink reservoir.

2. The printing device of claim 1, wherein the at least one of the heater and the cooler are configured so that a temperature measured at the at least one of the print head and the ink reservoir is between 0 and 25° C. and a temperature measured at the substrate plate is between 25 and 60° C.

3. The printing device of claim 1, wherein the printing device comprises the cooler, wherein the cooler is at the at least one of the print head and the ink tank.

4. The printing device of claim 1, wherein the printing device comprises the heater, wherein the heater is downstream of the print head.

5. The printing device of claim 4, wherein the printing device further comprises the cooler, wherein the cooler is arranged on at least one feed duct of the print head.

6. The printing device of claim 4, wherein the printing device further comprises the cooler, wherein the cooler is arranged on the ink tank.

7. The printing device of claim 4, wherein the printing device further comprises the cooler, wherein the cooler comprises a housing within which the at least one of the print head and the ink reservoir are arranged.

8. The printing device of claim 5, wherein the heater comprises a thermal block arranged in contact with the substrate plate.

9. The printing device of claim 5, wherein the heater comprises a system for infrared irradiation of the substrate plate.

10. The printing device of claim 5, wherein the heater comprises a circulation zone configured for the passage of a flow of heat transfer fluid, wherein the substrate plate is arranged to cover the circulation zone.

11. The printing device of claim 5, comprising a cover configured to cover the substrate plate, said cover comprising the heater.

12. The printing device of claim 1, wherein the printing device is configured for isolating the substrate plate.

13. The printing device of claim 1, wherein the printing device is configured for moistening the substrate plate.

14. The printing device of claim 1, comprising an enclosure configured to cover the substrate plate, wherein the enclosure comprises the heater and a temperature-humidity controller.

15. The printing device of claim 14, wherein the enclosure comprises at least one fan.

16. A method for performing enzymatic synthesis of biomolecules with a printing device, wherein the printing device comprises an ink reservoir, a print head, and a substrate plate, the method comprising:
providing ink to the ink reservoir, wherein the ink comprises synthesis reagents,
generating a temperature differential between the substrate plate and at least one of the ink reservoir and the print head, wherein the temperature differential is at least 10° C., and wherein a first temperature measured at the at least one of the ink reservoir and the print head is between 0 and 25° C., and a second temperature measured at the substrate plate is between 25° C. and 60° C.,
generating a plurality of ink droplets at the print head, wherein the print head is connected to the ink reservoir, and
depositing the plurality of ink droplets onto the substrate plate.
